(19) United States
(12) Patent Application Publication
(10) Pub. No.: US 2005/0276500 A1
(43) Pub. Date: Dec. 15, 2005

(54) Image encoding apparatus, and image processing apparatus and its control method

(75) Inventors: Tadayoshi Nakayama, Tokyo (JP); Hiroki Kishi, Kanagawa-ken (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/152,052

(22) Filed: Jun. 15, 2005

(30) Foreign Application Priority Data
Jun. 15, 2004 (JP) 2004-177347
Jun. 15, 2004 (JP) 2004-177348

(51) Int. Cl. G06K 9/36

(52) U.S. Cl. 382/251

(57) ABSTRACT

This invention generates target encoded data by suppressing an arithmetic precision drop by executing processes such as orthogonal transformation and the like using the number of bits of an input image in place of reducing the number of bits at the time of input upon encoding an image. Upon generating baseline JPEG encoded data, a quantization table for an 8-bit image is stored in a quantization table storage unit. When an interpreter outputs information indicating that each color component per pixel of input image data is 16 bits, a bit shift unit multiplies the quantization table stored in the quantization table storage unit by the 8th power of 2 or {8th power of 2+1}. A quantizer quantizes coefficients output from a DCT unit on the basis of the quantization table stored in the quantization table storage unit, and a Huffman encoder encodes the quantization result to Huffman codes. A header is created by setting information indicating baseline JPEG and the quantization table stored in the quantization table storage unit, thus generating encoded data.

### FIELD OF THE INVENTION

The present invention relates to an encoding technique of image data.

### BACKGROUND OF THE INVENTION

In JPEG as an international standard encoding scheme of still image data, encoding/decoding processes of color image data of 8 bits per component and color image data of 12 bits per component are specified as a lossy encoding scheme using discrete cosine transformation (DCT). Encoding of an 8-bit image is classified as a Baseline process, and that of a 12-bit image, including 8-bit image, is classified as an Extended DCT-based process. This is specified in a reference “ITU-T recommendation T.81 (ISO/IEC 10918-1)”.

Table B.2 in Section B.2.2. of Annex B of this reference specifies the sizes and values of frame header parameters. Also, the numbers of bits to be encoded/decoded are specified as the second parameter P. Baseline sequential DCT, i.e. the Baseline process is limited to an 8-bit image, and the Extended DCT-based process including Extended sequential DCT and progressive DCT can encode/decode 8- and 12-bit images. The number of encoded bits in image data is described in the frame header parameter, and a decoding process is done based on the parameter upon decoding. Hence, the number of encoded bits is equal to the number of bits of image data after decoding for both 8- and 12-bit images.

A color image input device used so far generates data with a precision of 8 bits or less per component in terms of technical problems and cost, and JPEG compression normally indicates baseline JPEG that compresses 8-bit data.

In recent years, along with the improvement of the precision of an image input device, a digital camera, scanner, and the like can easily generate image data with a precision exceeding 8 bits. Hence, the necessity of Extended sequential DCT-based JPEG that can compress 12-bit data is increasing accordingly.

A major difference between Extended sequential DCT-based JPEG and baseline JPEG is that the number of bits of input data is increased by 4 bits, and is extended so that a color converter, DCT transformer, and quantizer can process 16-fold values.

As is easily imaginable, if the number of bits is further extended, and maximum values that can be processed by respective processors are increased, data exceeding 12 bits can be encoded by the same process as JPEG although problems of a quantization table and Huffman table remain.

However, when data exceeding 12 bits are encoded like JPEG, such encoded data becomes non-standard data, and cannot be processed by general applications.

The flow of a baseline JPEG encoding process of an 8-bit full-color image per color component will be described below using the block diagram shown in FIG. 10.

Referring to FIG. 10, reference numeral 1101 denotes input 8-bit full-color image data per color component; 1103, a color converter; 1105, a DCT unit; 1107, a quantizer; 1109, a Huffman encoder; 1111, a quantization table storage unit; and 1113, encoded data generated by an encoding process.

When three components of a full-color image are three primary colors R, G, and B, the color converter 1103 converts the three primary colors R, G, and B into Y, Cb, and Cr as luminance and color difference signals. This color conversion normally uses the following formulas that comply with ITU-R BT.601:

$$Y = 0.299 \times R + 0.587 \times G + 0.114 \times B \\ Cb = ( - 0.299 \times R - 0.587 \times G + 0.886 \times B ) \times 0.564 + k \\ Cr = ( 0.701 \times R - 0.587 \times G - 0.114 \times B ) \times 0.713 + k \qquad ( 1 )$$

Note that a value k=128 is used in 8-bit data conversion.

The converted Y, Cb, and Cr components are transformed into DCT coefficients by the DCT unit 1105, and the DCT coefficients are sent to the quantizer 1107. The quantizer 1107 converts the DCT coefficients into quantization values by dividing them by a quantization step value read out from the quantization table storage unit 1111, and sends the quantization values to the Huffman encoder 1109.

The Huffman encoder 1109 encodes the quantization values to Huffman codes on the basis of a Huffman table (not shown) to generate encoded data 1113. In the encoded data 1113, various parameters such as an SOF₀ marker indicating baseline JPEG encoded data, image size, and the like, and quantization table information are written as header information. This quantization table information is obtained when it is read out from the quantization table storage unit 1111.

A processing system which supports the baseline JPEG encoding process shown in FIG. 11 has implementation that assumes an 8-bit full range input. Hence, a processing system which supports an Extended sequential DCT-based JPEG encoding process has implementation that assumes a 12-bit full range input.

In the conventional processing systems, the baseline JPEG encoding process supports only an 8-bit input, and the Extended sequential DCT-based JPEG encoding process supports only a 12-bit input. Hence, the following problems are posed.

Even when data exceeding 12 bits is compressed by Extended sequential DCT-based JPEG, such data must be encoded after it undergoes a process for rounding that data to 12 bits. That is, input image data is processed as a 12-bit image. On the other hand, upon encoding data by baseline JPEG, data must be rounded to 8 bits, and must then be encoded.

Under such circumstances, it is no use increasing the number of output bits by higher performance of an image input device, and high precision of image data cannot be reflected in the compression-encoded data. That is, the image quality of a decoded image remains the same as that obtained so far without enjoying the benefit of higher performance of an input image device.

On the other hand, a demand for higher image quality is increasing currently, and vendors are beginning to develop devices which can process multi-bit data exceeding 8 bits so as to attain higher image quality of the devices. For example, some products of digital cameras and scanners can easily generate image data with a precision over 8 bits per color component.

When an image input device inputs each color component with a multi-bit precision exceeding 8 bits, and an image output device outputs an image with an 8-bit precision, a bit rounding process is required. When the image output device receives only data with an 8-bit precision, the image input device must convert input data into 8-bit data and output the converted data. In this case, the image input device temporarily converts input multi-bit data into 8-bit data, applies an image compression process to the 8-bit data, and outputs the compressed data to the output device. However, the multi-bit input function of the image input device is not effectively used, and it becomes useless in practice.

### SUMMARY OF THE INVENTION

The present invention has been made in consideration of the aforementioned problems, and has as its object to provide a technique for generating target encoded data by suppressing an arithmetic precision drop by executing processes such as orthogonal transformation and the like using the number of bits of an input image in place of reducing the number of bits at the time of input upon encoding an image. It is another object of the present invention to provide a technique which generates a high-precision, high-quality decoded image while compression-encoding image data to be transferred from an image input device to an image output device.

In order to achieve the above objects, for example, an image encoding apparatus of the present invention comprises the following arrangement. That is, there is provided an image encoding apparatus for generating encoded data, a decoded image of which has each color component of M bits per pixel, comprising:

storage means for storing a first quantization table used to generate the M-bit encoded data;

quantization means for, when the number of bits of each color component per pixel of an image to be encoded is N (N>M) bits, quantizing an orthogonal conversion result of the image to be encoded using a second quantization table obtained by multiplying a quantization step value of the first quantization table by a magnification determined by M and N;

encoding means for entropy-encoding the quantization result of the quantization means; and

output means for appending header information according to the first quantization table to encoded data generated by entropy encoding and outputting the encoded data.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram of an encoding unit in the second embodiment;

FIG. 2 is a block diagram of a decoding unit in the second embodiment;

FIG. 3 is a block diagram of an encoding unit in the third embodiment;

FIG. 4 is a block diagram of a decoding unit in the third embodiment;

FIG. 5 is a block diagram of the overall apparatus in the second embodiment;

FIG. 6 is a block diagram of the overall apparatus according to the second embodiment;

FIG. 7 is a block diagram of a copying machine to which the second embodiment is applied;

FIG. 8 is a flowchart showing the processing sequence of a document scan process in the second embodiment;

FIG. 9 is a flowchart showing the processing sequence of a print process in the second embodiment;

FIG. 10 is a block diagram showing the arrangement of a conventional encoding apparatus;

FIG. 11 is a block diagram showing the arrangement of an encoding apparatus according to the first embodiment;

FIG. 12 is a block diagram showing the arrangement of an encoding apparatus according to a modification of the first embodiment;

FIG. 13 is a block diagram showing an apparatus arrangement when the encoding apparatus of the first embodiment is applied to a digital still camera; and

FIG. 14 is a flowchart showing an encoding processing sequence of a sensed image in the first embodiment.

### DETAILED DESCRIPTION OF THE PREFERRED EMBODIMENTS

Preferred embodiments according to the present invention will be described in detail hereinafter with reference to the accompanying drawings.

### First Embodiment

This embodiment will exemplify an encoding apparatus for generating encoded data from 16-bit image data per component, which obtains baseline JPEG encoded data (each color component of a decoded image is 8 bits), and Extended sequential DCT-based JPEG encoded data each color component of a decoded image is 12 bits).

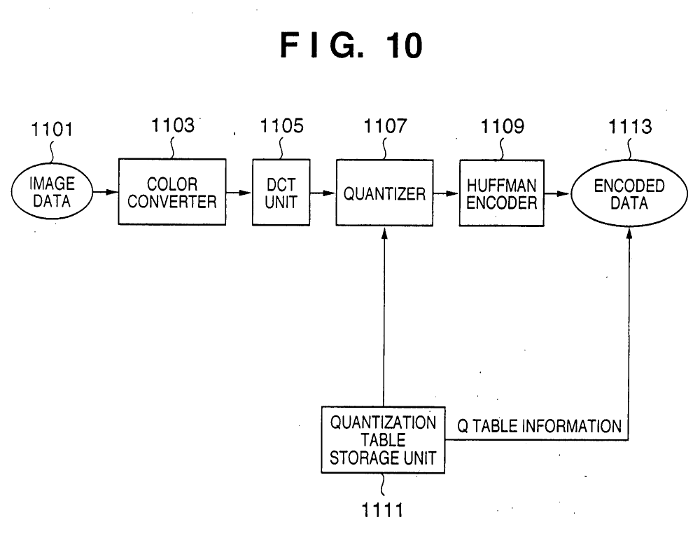

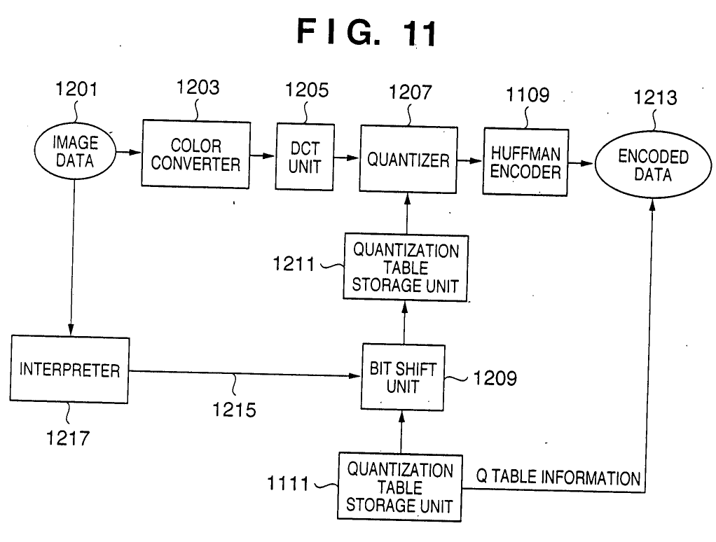

FIG. 11 is a block diagram of an encoding apparatus of this embodiment. The difference from FIG. 10 is that processors except for the Huffman encoder 1109 and quantization table storage unit 1111 in FIG. 10 have processing performance that supports a 16-bit full range input. More specifically, the number of bits to be processed is extended by 8 bits in the MSB direction.

In order to distinguish the processors except for the above two processors from the conventional 8-bit compatible processors, different numbers are given as follows.

Reference numeral 1201 denotes input 16-bit full-color image data per color; 1203, 1205, and 1207, a 16-bit data compatible color converter, DCT (orthogonal transformation) unit, and quantizer; and 1213, encoded data generated by executing an encoding process of 16-bit data.

In this embodiment, the following processors and image information are newly added.

Reference numeral 1209 denotes a bit shift unit; 1211, a quantization table storage unit which stores a first quantization table; and 1217, an interpreter which determines the number of bits of each color component of input image data (to be encoded). When an input image is stored in a storage device as an image file, the number of bits is determined by interpreting its header. When image data is input via a communication with an external device, information received upon negotiation of the communication is interpreted. The interpretation result of the interpretation unit 1217 is output to the bit shift unit 1209 as a signal 1215.

Note that the quantization table storage unit 1111 inherited from the block diagram of the prior art stores a second quantization table. This quantization table storage unit 1111 stores a conventional quantization table which assumes and supports the number of bits of a decoded image as 8 bits.

The first and second quantization tables will be briefly explained below. The first quantization table is used in an encoding process, and the second quantization table is written in header information of encoded data under the assumption that it is used in a decoding process.

As will be described later in modification 3, the second quantization table is normally used in the decoding process. However, when codes are converted by rewriting the quantization table in the header of a code stream, the table used in the decoding process is the rewritten quantization table, and the second quantization table is not always used.

The processing contents of the arrangement of FIG. 11 will be explained below.

The interpreter 1217 interprets input image data to determine the number of bits used to express each of color components R, G, and B, and outputs the interpretation result to the bit shift unit 1209. Upon reception of a message indicating that each color component of the input image is 16 bits, the bit shift unit 1209 shifts a quantization step value of quantization table information stored in the quantization table storage unit 1111 by 8 bits (=16−8) to the MSB side (256 times), and stores the result in the quantization table storage unit 1211 as the first quantization table.

The 16-bit full color image data 1201 per color undergoes a color conversion process in the 16-bit range by the color converter 1203. This color conversion is processed in accordance with aforementioned formulas (1) that comply with ITU-R BT.601. Note that k=128 is used in case of 8-bit data, but the color conversion process is done using k=32768 in case of 16-bit data.

The DCT unit 1205 performs orthogonal transformation in the 16-bit range, and outputs coefficients as its result to the quantizer 1207. The quantizer 1207 divides the orthogonal transformation coefficients by the quantization step of the quantization table stored in the quantization table storage unit 1211. Note that the quantization table storage unit 1211 stores a quantization table for 16 bits, as described above. That is, the level of the division result is substantially equivalent to that obtained by performing DCT transformation of an 8-bit image per color component, and quantizing its coefficients. Although the level of the quantization values remains the same, the values do not always completely match, and have slight differences depending on coefficient positions. Such differences correspond to those of arithmetic precisions upon processing 8-bit data and 16-bit data.

The Huffman encoder 1109 generates a code stream 1213 by encoding the values after quantization process to Huffman codes on the basis of a Huffman table (not shown). In header information of the code stream 1213, various parameters including an SOF₀ marker indicating baseline JPEG encoded data, image size, and the like, and the quantization table information stored in the quantization table storage unit 1111 are written.

In the above description, each color component of input data is 16 bits, and has a range about 256 times that of conventional 8-bit data. Hence, DCT coefficients obtained by applying color conversion and DCT transformation to the 16-bit data have 256-fold values compared to the conventional values. When these DCT coefficients are divided by the values in the table obtained by multiplying the conventional 8-bit quantization table by 256 (=2\hat{ }8), quantization values as division results have the same level as that upon encoding conventional 8-bit data. As a result, a Huffman table upon encoding the conventional 8-bit data can be used intact.

This difference appears as that of the code size after Huffman encoding in case of encoding, and as an image quality difference in case of decoding. In this manner, the processing result of 16-bit data is more preferable than that of 8-bit data. That is, it is demonstrated by simulation that the code size is smaller and the image quality upon decoding becomes better.

In the above example, the number of bits of each color component of input image data is 16 bits, but may be 8 to 15 bits.

When the number of bits of input data is (8+n) bits, the bit shift unit 1209 receives 8+n as image information 1215, and stores a quantization table obtained by shifting the readout second quantization table by n bits to the left on the basis of the image information as the first quantization table in the quantization table storage unit 1211.

For example, when it is determined that each color component of input image data is 12 bits (n=4), the bit shift unit 1209 shifts the quantization step value of the quantization table stored in the quantization table storage unit 1111 by 4 bits (=12−8) to the MSB side (multiplying it by 16), and stores the result as the first quantization table in the quantization table storage unit 1211. Other processes are the same as those described above.

When it is determined that each color component of input image data is 8 bits (n=0), the bit shift unit 1209 shifts the quantization step value stored in the quantization table storage unit 1111 by 0 bits, i.e. can store it in the quantization table storage unit 1211 without any shift process.

In the above description, the baseline JPEG encoded data is generated. Alternatively, Extended sequential DCT-based JPEG encoded data can be generated.

In this case, the quantization table stored in the quantization table storage unit 1111 is a table for a 12-bit image in place of that for an 8-bit image. The number of bits of input data is 12 bits or more. When each color component is expressed by (12+m) bits, the bit shift unit 1209 shifts the quantization step value stored in the quantization table storage unit 1111 by m bits to the left (2\hat{ }m=2^{m} times). An SOF₁ marker is set as a frame start marker in header information in the encoded data 1213, and a parameter indicating the number of bits of image data is set to be 12 (information indicating the 12-bit Extended sequential DCT-based JPEG format is appended).

### Description of Implementation Example

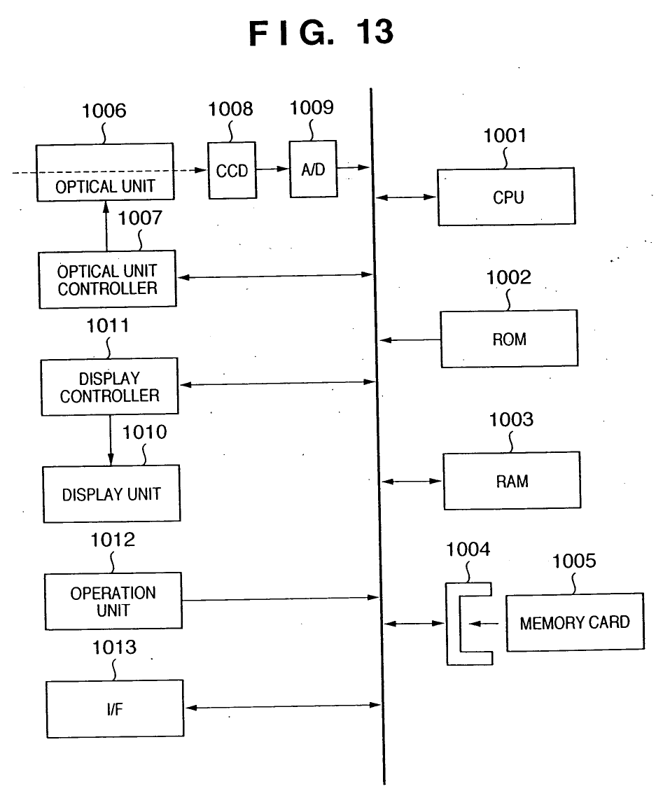

FIG. 13 is a block diagram when the image encoding apparatus of this embodiment is applied to a digital camera apparatus (image sensing apparatus).

Referring to FIG. 13, reference numeral 1001 denotes a CPU which controls the overall apparatus; 1002, a ROM which stores the processing sequence of the CPU 1001; and 1003, a RAM used as a work area. This RAM 1003 is used to temporarily store sensed image data so as to encode it. Also, areas serving as a first quantization table storage unit corresponding to the quantization table storage unit 1211 shown in FIG. 11, and a second quantization storage unit corresponding to the quantization table storage unit 1111 are assured on this RAM 1003.

Reference numeral 1004 denotes a connector used to connect a detachable memory card (storage medium) 1005. Reference numeral 1006 denotes an optical unit which comprises a lens, stop, and the like; and 1007, an optical unit controller for controlling the optical unit 1006. Reference numeral 1008 denotes an image sensing element (CCD); and 1009, an A/D converter. This A/D converter 1009 can output an analog signal of each color component from the CCD 1008 as the number of bits (8 to 16 bits) in accordance with an instruction from the CPU 1001.

Reference numeral 1010 denotes a display unit which comprises a liquid crystal display; and 1011, a display controller which controls display on the display unit 1010.

Reference numeral 1012 denotes an operation unit including a shutter button, various menu select and mode dials, and the like; and 1013, an interface (e.g., a USB interface) used to connect an external device.

In the above arrangement, the user can select a compression mode upon storing a sensed image in the memory card 1005 from a baseline JPEG mode as encoding mode of an 8-bit image, and a 12-bit Extended sequential DCT-based JPEG mode by operating the operation unit 1012. Also, the user can switch the number of output bits from the A/D converter 1009 within the range from 8 to 16 in accordance with the precision set by the operation unit 1012. Note that the number of signal lines of the A/D converter 1009 is 16. Therefore, if N bits are selected as the number of bits to be processed, the A/D converter 1009 outputs significant data onto the lower N bits, and always outputs zero onto the upper “16−N” bits.

Normally, an image which undergoes AF control when the shutter button is at the half stroke position and is sensed when it is at the full stroke position is compressed and written in the memory card 1005. The AF process itself is not directly related to this invention, and a sensed image compression process when the shutter button is at the full stroke position will be described below.

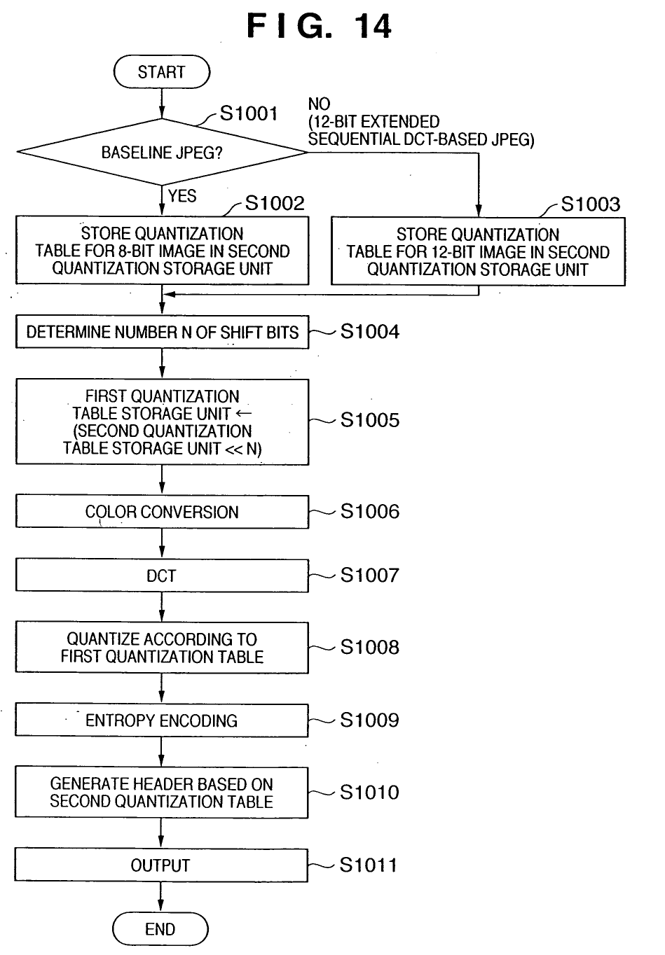

FIG. 14 is a flowchart showing the sequence of the image compression process in this case.

It is checked in step S1001 if the baseline JPEG encoding mode in which each color component of a pixel of a decoded result is 8 bits or the Extended sequential DCT-based JPEG encoding mode in which each color component of a pixel of a decoded result is 12 bits is selected as the encoding mode.

If the baseline JPEG encoding mode is selected, the flow advances to step S1002, and a quantization table for an 8-bit image is stored in the second quantization table storage unit (assured on the RAM 1003). On the other hand if the Extended sequential DCT-based JPEG encoding mode is selected, the flow advances to step S1003, and a quantization table for a 12-bit image is stored in the second quantization table storage unit.

In step S1004, the number N of bits to be shifted when the quantization table of the second quantization table storage unit is stored in the first quantization table storage unit is determined. For example, the number of significant bits to be output from the A/D converter 1009 is defined as M (8≦M≦16), Q=8 when the table stored in the second quantization table storage unit is the quantization table for an 8-bit image, and Q=12 when it is the quantization table for a 12-bit image. Then, the number N of shift bits is calculated by:
N=M−Q

After the number N of shift bits is determined in this way, the flow advances to step S1005, and a result obtained by shifting the quantization table (quantization step value) stored in the second quantization table storage unit by the determined number N of bits to the left (2\hat{ }N times) is stored in the first quantization table storage unit.

After that, RGB data of the sensed image is converted into the YCbCr color space expressed by luminance and color difference components in step S1006, and DCT transformation is made in step S1007. Note that the effective range of the arithmetic operations in these steps S1006 and S1007 is at least M bits.

In step S1008, quantization is made on the basis of the quantization table (that after the shift process) stored in the first quantization table storage unit. In step S1009, entropy encoding is made. In step S1010, the quantization table stored in the second quantization table storage unit is stored in the header of the JPEG encoded data, and information used to identify the selected mode is stored in the header. As a result, since the header and code stream are formed, they are output to and written in the memory card 1005 in step S1011.

In the above description, it is especially noted that each color component of input image data is not only 8 bits but also 9 bits or more upon generating baseline JPEG encoded data. Since the color conversion and DCT transformation as middle processes perform arithmetic processes in the range using the number of bits accordingly, the arithmetic precision is high, and the round size and process can be minimized. Consequently, the image quality of an image upon decoding the encoded data can be improved.

<Modification 1>

In FIG. 11, the bit shift process is done when the quantization table stored in the quantization table storage unit 1111 (second quantization table storage unit in the flowchart of FIG. 14) is stored in the quantization table storage unit 1211 (first quantization table storage unit in the flowchart of FIG. 14). Alternatively, the method to be described below is available.

In this method, the quantization table stored in the quantization table storage unit 1111 is a table for an 8-bit image, and a table obtained by multiplying the quantization table read out from the quantization table storage unit 1111 by 16 (left shift by 4 bits) is written as the second quantization table in the header information.

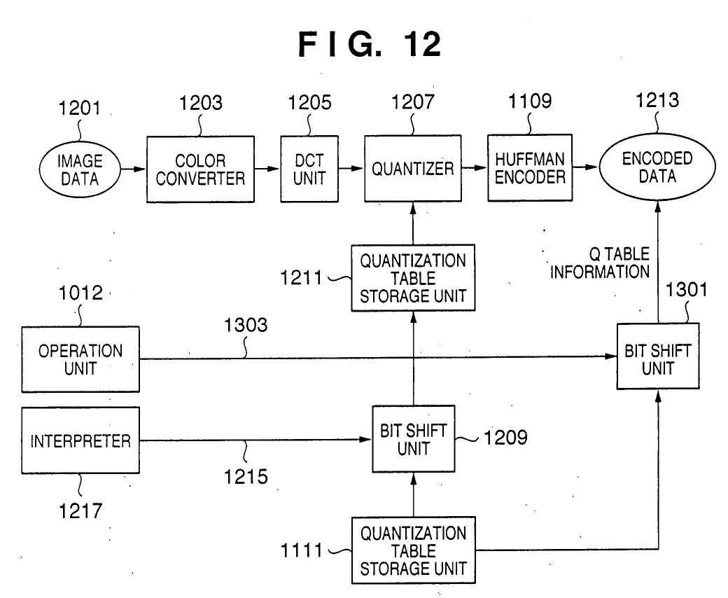

In this modification 1, a new bit shift process is required between the quantization table storage unit 1111 and code stream 1213. In the block diagram of FIG. 12, this process is provided as a bit shift unit 1301, and control information 1303 for this bit shift unit is added.

The control information 1303 is used to switch whether baseline JPEG encoded data or Extended sequential DCT-based JPEG encoded data is to be generated, and is based on an instruction from the operation unit 1012.

In the block diagram of FIG. 11, when the encoding mode is switched between the baseline JPEG encoding mode and Extended sequential DCT-based JPEG encoding mode, the contents of the quantization table storage unit 1111 must be changed, and the control method of the bit shift unit 1209 must also be switched.

However, in the block diagram of FIG. 12, the quantization table stored in the quantization table storage unit 1111 can be fixed to a table for an 8-bit image, and the bit shift unit 1209 can perform shift control depending only on the number of bits of input image data. The bit shift unit 1301 is controlled based on the control information 1303 to change the marker and parameter, thus selectively generating the baseline JPEG encoded data and Extended sequential DCT-based encoded data.

Upon reception of a generation instruction of baseline JPEG encoded data, the bit shift unit 1301 outputs the quantization table in the quantization table storage unit 1111 without any shift process. On the other hand, upon reception of a generation instruction of Extended sequential DCT-based JPEG encoded data, since 12−8=4, the bit shift unit 1301 can shift the quantization table of the quantization table storage unit 111 by 4 bits to the left (MSB side), and can output the shifted table.

<Modification 2>

In the above embodiment, baseline JPEG encoded data and Extended sequential DCT-based JPEG encoded data, which are generated by encoding 16-bit data, include the same parts generated by Huffman encoding, except for their contents of the header information in the encoded data.

As can be understood from this description, baseline JPEG encoded data and Extended sequential DCT-based JPEG encoded data generated by the encoding apparatus of this embodiment are mutually convertible by only rewriting the header information.

Hence, modification 2 relates to mutual conversion of encoded data. A rewrite process of header information for mutually converting encoded data will be described below.

Conversion Method From Baseline JPEG Encoded Data to Extended Sequential DCT-based JPEG Encoded Data

1. Header information is interpreted to rewrite the marker, parameter, and table as follows.

2. The frame start marker is changed from an SOF₀ marker to an SOF₁ marker.

3. The parameter indicating the number of bits of image data is changed from 8 to 12.

4. Each quantization step value of the quantization table is changed to a 16-fold value.

Conversion Method From Extended Sequential DCT-based JPEG Encoded Data to Baseline JPEG Encoded Data

1. Header information is interpreted to rewrite the marker, parameter, and table as follows.

2. The frame start marker is changed from an SOF₁ marker to an SOF₀ marker.

3. The parameter indicating the number of bits of image data is changed from 12 to 8.

4. Each quantization step value of the quantization table is changed to a 1/16-fold value.

Even when each quantization step value of the quantization table in baseline JPEG encoded data is arbitrarily set, baseline JPEG encoded data can be converted to Extended sequential DCT-based encoded data. However, in order to convert Extended sequential DCT-based encoded data to baseline JPEG encoded data, each quantization step value of the quantization table in the Extended sequential DCT-based encoded data is preferably closer to a multiple of 16.

<Modification 3>

When the ratio of maximum values of 16-bit data and 8-bit data is accurately calculated, 65535/255=257. Hence, when encoded data generated by encoding 16-bit data is decoded as 8-bit data, a quantization table obtained by multiplying an inverse quantization table by 257 may be used.

More specifically, upon encoding 16-bit data, a quantization process is executed using a first quantization table obtained by multiplying a quantization table for 8 bits by 257. Upon executing a decoding process to obtain 8-bit data, the quantization table for 8-bit can be used as the second quantization table in an inverse quantization process.

Also, upon examining the ratio between the maximum values of 15-bit data and 8-bit data, 32767/255≈128.498. When this value is accurately rounded off, it becomes 128, i.e., a power of 2. However, since the value before rounding is very closer to 128.5, it may be rounded up to 129, without any real problem.

In the first embodiment and modification 2, the ratio of the first and second quantization tables is limited to a power of 2. However, as can be understood from the above description, the ratio of the two tables can be {power of 2+1}-fold in some cases depending on the relationship between the number of bits of data to be encoded, and that of data to be decoded.

Since a block diagram in case of the {power of 2+1}-fold, the bit shift unit 1209 in FIGS. 11 and 12 is replaced by a multiplier to multiply a power of 2+1, and a detailed description thereof will be omitted.

In the description given so far, only a case wherein the number of bits upon encoding is larger than that upon decoding has been exemplified. Of course, baseline JPEG encoded data generated by encoding 8-bit image data may be converted into Extended sequential DCT-based JPEG encoded data by rewriting its header, and the converted data may be decoded as 12-bit data. In this case, the number of bits upon decoding is larger than that upon encoding.

The first embodiment according to the present invention and its some modifications have been explained. The baseline JPEG encoded data and Extended sequential DCT-based JPEG encoded data generated by the apparatus or processing method of the above embodiment can be decoded by a general image viewer which supports baseline JPEG and Extended sequential DCT-based JPEG, the image quality obtained upon decoding encoded data of 16-bit image data is higher than the conventional data, and full compatibility between these two formats can be assured.

As described above, according to this embodiment, when transformation coefficients obtained by computing the orthogonal transforms of image data are quantized using the first quantization table, and quantization values are then entropy-encoded to generate encoded data, the second quantization table is written in the header information so as to decode encoded data using the second quantization table which has a relationship of a ratio of a power of 2 or a power of 2+1 with the first quantization table. Hence, encoded data generated by applying arithmetic and encoding processes to 16-bit data with a 16-bit precision can be decoded as baseline JPEG encoded data or Extended sequential DCT-based JPEG encoded data, thus improving the image quality of a decoded image.

### Second Embodiment

The second embodiment will explain a case wherein image data which is expressed by 16 bits per color component undergoes a JPEG encoding process to obtain an encoded bitstream, and that encoded bitstream is decoded to output an image which is expressed by 8 bits per color component.

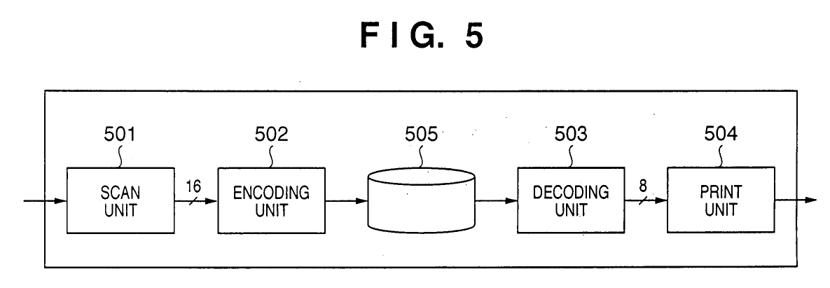

FIG. 5 is a block diagram of an image processing apparatus (copying machine) to which the second embodiment is applied.

Referring to FIG. 5, reference numeral 501 denotes a scan unit which scans a document image with a precision of 16 bits per color component; 502, an encoding unit; 503, a decoding unit; and 504, a print unit which receives and prints an image which is expressed by 8 bits per color component. Reference numeral 505 denotes a storage device which stores encoded data output from the encoding unit 502. The decoding unit 503 reads out encoded data from the storage device 505 in accordance with the print speed of the print unit 504, and performs a decoding process. As a result, a document scan process and print process can be asynchronously done, and a high-speed document scan process can be achieved. Note that the storage device 505 can comprise a semiconductor memory or a hard disk which has low cost per size, since it need only store a plurality of images.

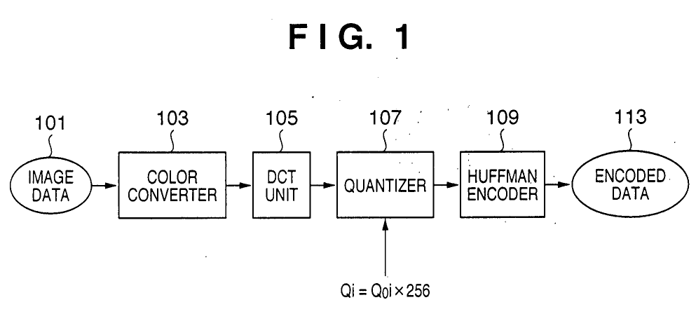

FIG. 1 is a block diagram of the encoding unit 502 in this embodiment.

Referring to FIG. 1, reference numeral 101 denotes full-color image data which is output from the scan unit 501 and is expressed by 16 bits per color component. Reference numeral 103 denotes a color converter which performs RGB→YCbCr color space conversion in the 16-bit range since this embodiment encodes an image from an image scanner by JPEG.

This color conversion is made according to formulas (2) that comply with ITU-R BT.601, and these formulas are described again:

$$Y = 0.299 \times R + 0.587 \times G + 0.114 \times B \\ Cb = ( - 0.299 \times R - 0.587 \times G + 0.886 \times B ) \times 0.564 + k \\ Cr = ( 0.701 \times R - 0.587 \times G - 0.114 \times B ) \times 0.713 + k \qquad ( 2 )$$

Note that k=128 when each color component is expressed by 8 bits. However, in the second embodiment, since each of R, G, and B components is expressed by 16 bits, a value k=32768 is used.

Reference numeral 105 denotes a DCT (orthogonal transformation) unit which also performs orthogonal transformation in the 16-bit range. Reference numeral 107 denotes a quantizer which quantizes coefficients obtained by orthogonal transformation by dividing them by a quantization step; 109, a Huffman encoder; and 113, encoded data generated by the encoding process.

Note that a quantization step Qi in the quantizer 107 is calculated by:
Qi=Q₀i×2\hat{ }(n−m)

(where x\hat{ }y indicates the y-th power of x)

Assuming that orthogonal transformation is made every 8×8 pixels, i=0, 1, . . . , 63, and Q₀i is a quantization step value used upon encoding an 8-bit image, n is the number of bits per color component of an input image, and m is the number of bits per color component of a decoded image.

Since this embodiment exemplifies a case wherein each color component is expressed by 16 bits and the decoding unit 503 decodes using 8 bits per color component, n=16 and m=8, and the quantization step value Qi used in the quantizer 107 is given by:
Qi=Q₀i×256
That is, Qi is also obtained by shifting Q₀i by 8 bits to the left (to the MSB side).

Since the color converter 103 and DCT unit 105 calculate in the 16-bit range, DCT coefficients are divided by Qi, i.e., the 256-fold value of the quantization step Q₀i for an 8-bit image, thus consequently obtaining 8-bit quantization values. Note that the image data 101 which is expressed by 16 bits per color component does not undergo 8-bit conversion before it is input to the color converter 103, but it undergoes 16-bit calculations in the color converter 103 and DCT unit 105. Hence, calculations can be made with higher precision than 8-bit calculations.

The Huffman encoder 109 encodes the quantization values to Huffman codes on the basis of a Huffman table (not shown) to generate the encoded data 113.

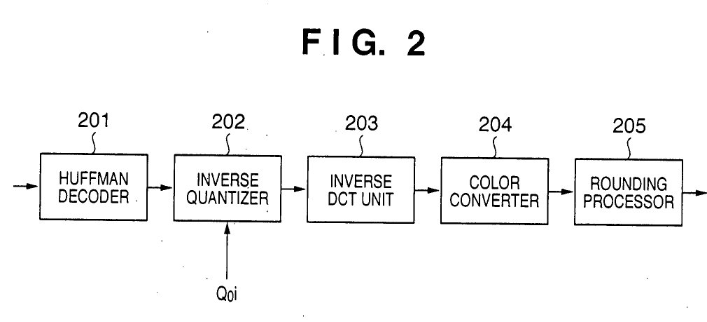

FIG. 2 is a block diagram of the decoding unit 503 in FIG. 5.

Referring to FIG. 2, reference numeral 201 denotes a Huffman decoder which receives the encoded data in FIG. 1 via the storage device 505, and performs entropy decoding. Reference numeral 202 denotes an inverse quantizer which inversely quantizes entropy-decoded data by the quantization step value Q₀i. Reference numeral 203 denotes an inverse DCT unit; 204, an inverse color converter; and 205, a rounding processor.

The Huffman decoder 201 decodes Huffman codes in the received encoded data 113 on the basis of a Huffman table (not shown) to generate quantization values, and transmits the quantization values to the inverse quantizer 202. The inverse quantizer 202 inversely quantizes the quantization values using the quantization step Q₀i to generate DCT coefficients (integer calculations are made until this process). Next, the inverse DCT unit 203 computes inverse DCTs of the obtained DCT coefficients to generate image data of color conversion data YCbCr. The inverse color converter 204 color-converts the color conversion data. In this case, since this embodiment aims at printing, the inverse color converter 204 converts YCbCr data into the YMC color space in place of the RGB color space. The rounding processor 205 applies a rounding process of fractions after the decimal point to density data of the obtained Y, M, and C color components (e.g., by rounding off fractions below the decimal point), thereby generating a recording image.

As a result, upon encoding, all color components R, G, and B are input with a 16-bit precision, and undergo color conversion and DCT transformation. The DCT coefficients are quantized and encoded by the 256-fold value of the quantization step value Q₀i for an 8-bit image. Hence, the arithmetic precision of the color conversion and DCT transformation is twice that for an 8-bit image. Data after quantization has the same format as that obtained upon encoding an 8-bit image, but it does not always have the same value. This is because 16-bit calculations are made up to DCT transformation. Therefore, since arithmetic losses are fewer than 8-bit DCT transformation, higher precision is reflected in data after quantization.

A practical apparatus arrangement and processing sequence in the second embodiment will be described below.

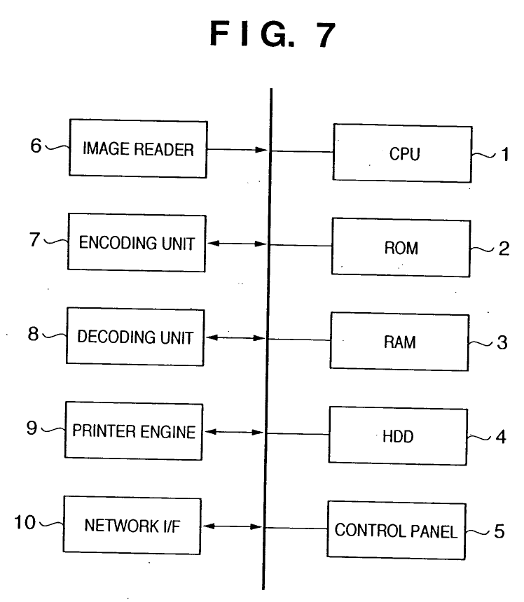

FIG. 7 is a block diagram of the copying machine in this embodiment. Referring to FIG. 7, reference numeral 1 denotes a CPU which controls the overall copying machine; 2, a ROM which stores the processing sequence (program); and 3, a RAM which is used as a work area of the CPU 1.

Reference numeral 4 denotes a hard disk drive (HDD) which temporarily stores an image file, and corresponds to the storage device 505 in FIG. 5. Reference numeral 5 denotes a control panel which has a liquid crystal display and various buttons (switches). Reference numeral 6 denotes an image reader which scans a document image. The image reader 6 scans R, G, and B color components with a 16-bit precision. Note that the image reader 6 equips an ADF (auto document feeder) and can scan a plurality of pages of images sequentially.

Reference numeral 7 denotes an encoding unit which encodes an image and corresponds to the encoding unit 502 (FIG. 1) shown in FIG. 5. Reference numeral 8 denotes a decoding unit which corresponds to the decoding unit 503 (FIG. 2) in FIG. 5. Reference numeral 9 denotes a printer engine. As the printer engine 9, an ink-jet printer, laser beam printer, or the like may be used, but its printing system is not particularly limited.

Reference numeral 10 denotes a network interface used to connect the copying machine to the network. With this network interface 10, the copying machine of this embodiment can serve as a network scanner and network printer.

With this arrangement, when a document to be copied is set on the ADF of the image reader 6 (a plurality of documents may be set), and a copy start instruction is input from the control panel 5, the image reader 6 sequentially scans documents with a 16-bit precision for each of R, G, and B color components, and temporarily stores the scan result in the HDD 4 as a file.

The HDD 4 stores image data of respective pages. In this case, the CPU 1 controls the encoding unit 502 to perform compression encoding in turn from a first image file that completes the storage process.

Since the encoding unit 502 has the arrangement shown in FIG. 1, it receives an image file designated by the CPU 1 as the image data 101, and the color converter 103 and DCT unit 105 respectively execute processes in the 16-bit range. The quantizer 107 quantizes using the quantization step Qi as the 256-fold value of the quantization step value Q₀i used upon generating 8-bit encoded data, and the Huffman encoder 109 performs an entropy-encoding process. The encoded result is stored as a baseline JPEG file in the HDD 4. At this time, the original image data (image data of 16 bits per color component) file before encoding has already been processed, and is deleted from the HDD 4.

On the other hand, a print process is executed asynchronously to the aforementioned document scan/encoding process. In this print process, whether or not the compression-encoded file is stored in the HDD 4 is monitored, and if such file is stored, the file undergoes a decoding process. The decoded file undergoes a print process using the printer engine 9, and the printed compression-encoded file is deleted. This process is repeated as long as images to be printed remain.

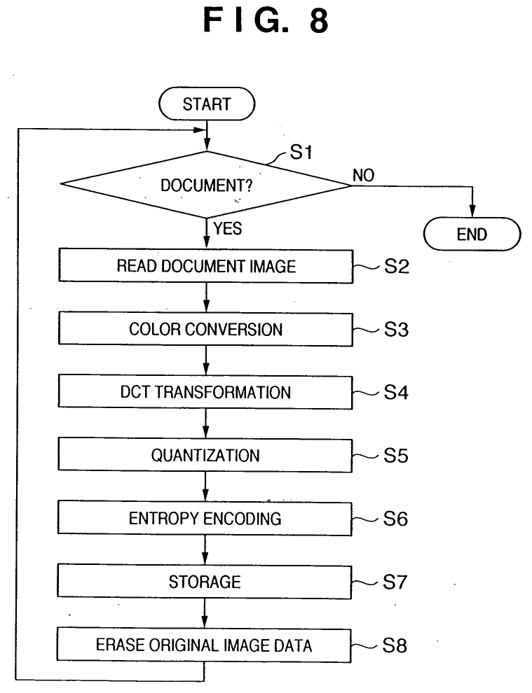

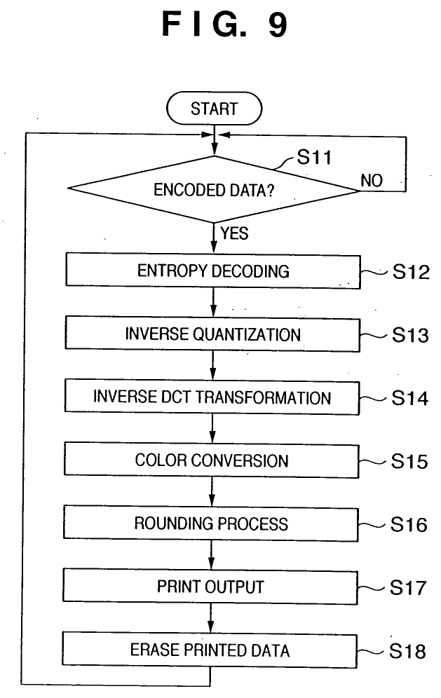

As a result, the HDD 4 stores scanned images in turn after compression encoding, and the stored compression-encoded image data undergo the decoding process in their storage order to perform the print process. Hence, the HDD 4 does not require any large-size storage area, and a RAM may be used instead in some cases. The aforementioned process will be described below with reference to the flowcharts of FIGS. 8 and 9.

The document scan process upon copying a document will be described below with reference to the flowchart of FIG. 8. This process is launched when a copy start instruction is input from the control panel 5.

It is checked in step S1 if a document is set. This checking process is attained on the basis of a signal from a sensor (not shown) provided to the ADF.

If it is determined that a document is set, one document is fed to the scan surface to scan a document image in step S2. In this case, the document image is scanned with a 16-bit precision for each of R, G, and B color components, and the image data is temporarily stored in the HDD 4. Upon completion of scanning of one image, RGB→YCbCr color conversion is executed in step S3, and DCT transformation is made in step S4. The arithmetic processes in steps S3 and S4 are done in the 16-bit range.

After that, the flow advances to step S6 to perform entropy encoding. In step S7, encoded data is stored in the HDD 4 as a baseline JPEG file (compressed image file). Upon completion of this storage process, since original image data before compression becomes unnecessary, it is deleted (step S8), and the flow returns to step S1. Therefore, when a plurality of documents are set on the ADF and a copy instruction is issued, the processes in steps S2 to S8 are repeated as many as the number of set documents.

The print process in this embodiment will be described below with reference to the flowchart of FIG. 9.

It is checked in step S11 if a compressed image file is stored in the HDD 4. The control waits until a compressed image file is stored.

If it is determined that a compressed image file is stored, the flow advances to step S12, and the decoding unit 8 decodes that file. The decoding unit 8 performs entropy decoding first. The decoding unit 8 inversely quantizes the decoded result by multiplying it by the quantization step value Q₀i in step S13. In step S14, the decoding unit 8 performs inverse DCT transformation to obtain image data on the YCbCr color space. Since this embodiment aims at printing out that image, data on the YMC color space (a black component K may be generated by further executing a UCR process in step S15) is generated. In this case, since data includes fractions below the decimal point, a rounding process of fractions below the decimal point (in this embodiment, the first decimal place is rounded off) is executed in step S16. As a result, since Y, M, and C color components (8 bits each) to be printed are generated, they are output to the printer engine 9 at predetermined timings in step S17, thus executing a print process. Upon completion of the print process, since the compressed image file used in that process becomes unnecessary, it is deleted from the HDD 4, and the processes in step S11 and subsequent steps are repeated.

As described above, according to the second embodiment, in an apparatus in which the number of bits of each color component in an image input unit (image reader in this embodiment) is larger than that of an image output unit (printer in this embodiment), encoded data which can be decoded to high-quality image data that fully utilizes the number of bits to be processed by the image input unit can be generated, while standard baseline JPEG encoded data is transferred to the image output unit. Generation of the baseline JPEG encoded data and the rounding process in decoding can be executed once in practice after conversion to the output color space upon decoding.

In the second embodiment, the image reader and printer have been exemplified as the image input and output devices. Alternatively, a digital camera (that can store RAW image data) and a display device may be used as the image input and output devices. Especially, when the display device is adopted as the image output device, the color converter 204 in FIG. 2 need only perform YCbCr→RGB color space conversion. Hence, the output color space is not limited to YMC.

### Third Embodiment

In the second embodiment, the number of bits to be processed by the image input device is larger than that to be processed by the image output device.

The third embodiment will explain a case wherein this relationship is reversed. That is, a case will be explained wherein an 8-bit input image is encoded, and the obtained encoded image data (baseline JPEG encoded data) is decoded to generate a 16-bit image.

Normally, in order to obtain such decoded image, an 8-bit decoded image per color component is generated first, and each color component is shifted by 8 bits to the left (to the MSB direction). However, the lower 8 bits of the generated 16-bit data are all “0”s, and the generated image data is no different from the 8-bit decoded result in terms of image quality.

Hence, the third embodiment will exemplify a case wherein 8-bit encoded data per color component (baseline JPEG data) is decoded to a 16-bit image per color component with a high precision.

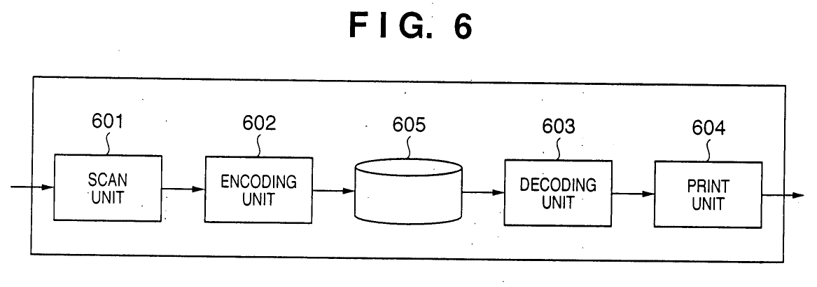

FIG. 6 is a block diagram of an image processing apparatus according to the third embodiment.

Referring to FIG. 6, reference numeral 601 denotes a scan unit; 602, an encoding unit; 603, a decoding unit; 604, a print unit; and 605, a storage device. Since the functions of these units are substantially the same as those in FIG. 5, a description thereof will be omitted.

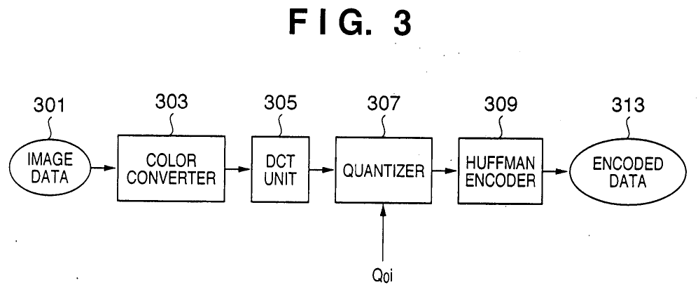

FIG. 3 is a block diagram of the encoding unit 602. Referring to FIG. 3, reference numeral 301 denotes input full color image data of 8 bits per color; 303, a color converter; 305, a DCT unit; 307, a quantizer; 309, a Huffman encoder; and 313, encoded data generated by an encoding process.

In the encoding unit 602, since the processing contents of processors other than the quantizer 307 are substantially the same as those in the second embodiment except that data to be processed is changed from 16 bits to 8 bits, a description of these processes will be omitted.

The quantizer 307 executes a quantization process using a quantization step value Q₀i for an 8-bit image. Note that i is a serial number of DCT coefficients, and i=0, 1, . . . , 63 since DCT transformation is normally made every 8×8 pixels.

The process of the encoding unit 602 in the third embodiment has been described. The decoding unit 603 will be explained below.

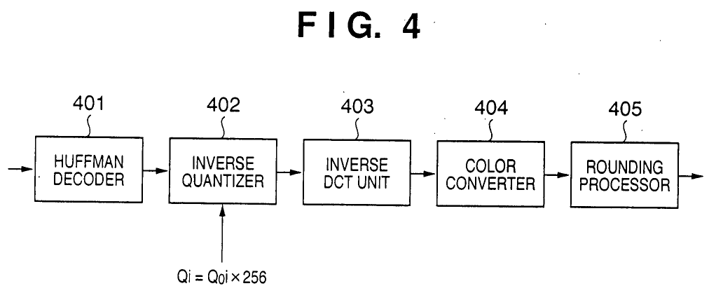

FIG. 4 is a block diagram of the decoding unit 603. Referring to FIG. 4, reference numeral 401 denotes a Huffman decoder; 402, an inverse quantizer; 403, an inverse DCT unit; and 404, a color converter.

Since these processors except for the inverse quantizer 402 perform substantially the same operations as those in the decoding unit 503 in the second embodiment, a description thereof will be omitted.

The inverse quantizer 402 executes inverse quantization using a quantization value Qi as a 256-fold value of the quantization step value Q₀i for an 8-bit image.

With this inverse quantization, 16-bit DCT coefficients can be used. After that, the color converter 404 performs color conversion, and a rounding processor 405 executes a rounding process of fractions below the decimal points. Hence, 16-bit data which has significant bits in the lower 8 bits can be generated, and an image with high image quality can be generated.

In the description of the second and third embodiments, data to be processed by a multi-bit processing apparatus is 16-bit data. However, the present invention is not limited to these embodiments, and 9- to 15-bit data may be used.

The above embodiments have exemplified the copying machine. However, the present invention is not limited to the copying machine as long as an apparatus has an encoding unit and decoding unit. The processes associated with respective processors may be implemented by a computer program. Normally, a computer program is stored in a computer-readable storage medium such as a CD-ROM or the like, and is copied to or installed in the system after the storage medium is set in a PC. Hence, such computer-readable storage medium is included in the scope of the present invention.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application Nos. 2004-177347 filed on Jun. 15, 2004 and 2004-177348 filed on Jun. 15, 2004, which are hereby incorporated by reference herein.

1. An image encoding apparatus for generating encoded data, a decoded image of which has each color component of M bits per pixel, comprising:
storage means for storing a first quantization table used to generate the M-bit encoded data;
quantization means for, when the number of bits of each color component per pixel of an image to be encoded is N (N>M) bits, quantizing an orthogonal conversion result of the image to be encoded using a second quantization table obtained by multiplying a quantization step value of the first quantization table by a magnification determined by M and N; and
encoding means for encoding the quantization result of said quantization means.

2. The apparatus according to claim 1, further comprising:
output means for appending header information according to the first quantization table to encoded data encoded by said encoding means and outputting the encoded data.

3. The apparatus according to claim 1, wherein the second quantization table is obtained by multiplying the quantization step value of the first quantization table by the “M−N”-th power of 2 or {“M−N”-th power of 2+1}.

4. An image encoding apparatus for generating encoded data, a decoded image of which has each color component of M bits per pixel, comprising:
a storage step of storing a first quantization table used to generate the M-bit encoded data;
a quantization step of quantizing, when the number of bits of each color component per pixel of an image to be encoded is N (N>M) bits, an orthogonal conversion result of the image to be encoded using a second quantization table obtained by multiplying a quantization step value of the first quantization table by a magnification determined by M and N; and
an encoding step of encoding the quantization result in the quantization step.

5. The method according to claim 4, further comprising:
an output step of appending header information according to the first quantization table to encoded data encoded in the encoding step and outputting the encoded data.

6. The method according to claim 4, wherein the second quantization table is obtained by multiplying the quantization step value of the first quantization table by the “M−N”-th power of 2 or {“M−N”-th power of 2+1}.

7. An image encoding apparatus for generating at least two different types of data, a decoded image of which has each color component of M bits per color or N (N>M) bits, comprising:
instruction means for instructing to generate first encoded data, a decoded image of which has each color component of M bits, or second encoded data, a decoded image of which has each color component of N bits;
storage means for storing a first quantization table used to generate the M-bit encoded data;
quantization means for, when the number of bits each color component per pixel of an image to be encoded is L bits, quantizing an orthogonal conversion result of the image to be encoded using a second quantization table obtained by multiplying a quantization step value of the first quantization table by a magnification determined by L and M;
encoding means for entropy-encoding the quantization result of said quantization means; and
output means for, when said instruction means issues a generation instruction of the first encoded data, appending header information according to the first quantization table to encoded data generated by entropy encoding, and outputting the encoded data, or for, when said instruction means issues a generation instruction of the second encoded data, appending header information according to the second quantization table to encoded data generated by entropy encoding, and outputting the encoded data.

8. The apparatus according to claim 7, wherein the second quantization table is obtained by multiplying the quantization step value of the first quantization table by the “M−N”-th power of 2 or {“M−N”-th power of 2+1}.

9. The apparatus according to claim 7, further comprising:
means for converting the generated encoded image data into another encoded image data by rewriting encoding type information and the quantization table in the header information of the generated encoded image data.

10. An image encoding method for generating at least two different types of data, a decoded image of which has each color component of M bits per color or N (N>M) bits, comprising:
an instruction step of instructing to generate first encoded data, a decoded image of which has each color component of M bits, or second encoded data, a decoded image of which has each color component of N bits;
a storage step of storing a first quantization table used to generate the M-bit encoded data;
a quantization step of quantizing, when the number of bits each color component per pixel of an image to be encoded is L bits, an orthogonal conversion result of the image to be encoded using a second quantization table obtained by multiplying a quantization step value of the first quantization table by a magnification determined by L and M;
an encoding step of entropy-encoding the quantization result in the quantization step; and
an output step of appending, when a generation instruction of the first encoded data is issued in the instruction step, header information according to the first quantization table to encoded data generated by entropy encoding, and outputting the encoded data, or appending, when a generation instruction of the second encoded data is issued in the instruction step, appending header information according to the second quantization table to encoded data generated by entropy encoding, and outputting the encoded data.

11. An image processing apparatus which comprises an image input unit for inputting image data in which each color component per pixel is expressed by M bits, and an image output unit for outputting image data in which each color component per pixel is expressed by N bits (N<M), comprising:
encoding means for encoding image data input by the image input unit; and
decoding means for decoding encoded data generated by said encoding means and supplying a decoded image to the image output unit,
said encoding means comprising:
orthogonal transformation means for performing orthogonal transformation of image data input by the image input unit;
quantization means for quantizing coefficients obtained by said orthogonal transformation means using a quantization step Qi given by:
Qi=Q₀i×2^{M-N}
when a quantization step value upon generating the N-bit decoded image is defined as Q₀i; and
entropy encoding means for entropy-encoding orthogonal transformation coefficients after quantization by said quantization means, and
said decoding means comprising:
entropy decoding means for entropy-decoding data encoded by said entropy encoding means;
inverse quantization means for inversely quantizing data obtained by entropy decoding using the quantization step Q₀i; and
inverse orthogonal transformation means for performing inverse orthogonal transformation of data obtained by said inverse quantization means.

12. The apparatus according to claim 11, further comprising:
storage means, interposed between said encoding means and said decoding means, for storing encoded data.

13. A method of controlling an image processing apparatus which comprises an image input unit for inputting image data in which each color component per pixel is expressed by M bits, and an image output unit for outputting image data in which each color component per pixel is expressed by N bits (N<M), comprising:
an encoding step of encoding image data input by the image input unit; and
a decoding step of decoding encoded data generated in the encoding step and supplying a decoded image to the image output unit,
the encoding step comprising:
an orthogonal transformation step of performing orthogonal transformation of image data input by the image input unit;
a quantization step of quantizing coefficients obtained in the orthogonal transformation step using a quantization step Qi given by:
Qi=Q₀i×2^{M-N}
when a quantization step value upon generating the N-bit decoded image is defined as Q₀i; and
an entropy encoding step of entropy-encoding orthogonal transformation coefficients after quantization in the quantization step, and
the decoding step comprising:
an entropy decoding step of entropy-decoding data encoded in the entropy encoding step;
an inverse quantization step of inversely quantizing data obtained by entropy decoding using the quantization step Q₀i; and
an inverse orthogonal transformation step of performing inverse orthogonal transformation of data obtained in the inverse quantization step.

14. An image processing apparatus which comprises an image input unit for inputting image data in which each color component per pixel is expressed by M bits, and an image output unit for outputting image data in which each color component per pixel is expressed by N bits (N>M), comprising:
encoding means for encoding image data input by the image input unit; and
decoding means for decoding encoded data generated by said encoding means and supplying a decoded image to the image output unit,
said encoding means comprising:
orthogonal transformation means for performing orthogonal transformation of image data input by the image input unit;
quantization means for quantizing coefficients obtained by said orthogonal transformation means using a quantization step Q₀i for generating the N-bit decoded image; and
entropy encoding means for entropy-encoding orthogonal transformation coefficients after quantization by said quantization means, and
said decoding means comprising:
entropy decoding means for entropy-decoding data encoded by said entropy encoding means;
inverse quantization means for inversely quantizing data obtained by entropy decoding using a quantization step Qi obtained by multiplying the quantization step value Q₀i by 2^{M-N}; and
inverse orthogonal transformation means for performing inverse orthogonal transformation of data obtained by said inverse quantization means.

15. The apparatus according to claim 14, further comprising:
storage means, interposed between said encoding means and said decoding means, for storing encoded data.

16. A method of controlling an image processing apparatus which comprises an image input unit for inputting image data in which each color component per pixel is expressed by M bits, and an image output unit for outputting image data in which each color component per pixel is expressed by N bits (N>M), comprising:
an encoding step of encoding image data input by the image input unit; and
a decoding step of decoding encoded data generated in the encoding step and supplying a decoded image to the image output unit,
the encoding step comprising:
an orthogonal transformation step of performing orthogonal transformation of image data input by the image input unit;
a quantization step of quantizing coefficients obtained in the orthogonal transformation step using a quantization step Q₀i for generating the N-bit decoded image; and
an entropy encoding step of entropy-encoding orthogonal transformation coefficients after quantization in the quantization step, and
the decoding step comprising:
an entropy decoding step of entropy-decoding data encoded in the entropy encoding step;
an inverse quantization step of inversely quantizing data obtained by entropy decoding using a quantization step Qi obtained by multiplying the quantization step value Q₀i by 2^{M-N ; and}
an inverse orthogonal transformation step of performing inverse orthogonal transformation of data obtained in the inverse quantization step.
